(19) United States
(12) Patent Application Publication
(10) Pub. No.: US 2006/0271427 A1
(43) Pub. Date: Nov. 30, 2006

(54) Method of displaying products to consumers

(76) Inventor: Lisa Marie Raimondo, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/141,501

(22) Filed: May 31, 2005

(51) Int. Cl. G06Q 30/00

(52) U.S. Cl. 705/14

(57) ABSTRACT

A retail display for consumer products and method of display. A first packaged disposable absorbent product exhibiting on the package a first brand identifier and a second packaged disposable absorbent product exhibiting on the package a second brand identifier different from said first brand identifier are disclosed. The second package is packaged separately from the first package. An additional mark is on each separately-packaged first and second disposable absorbent products, the additional mark being common to both, and the additional mark communicating an attribute common to each of said first and second disposable absorbent products. Both the first or second brand identifier and the common mark are observable by a consumer at a retail point of sale.

### FIELD OF THE INVENTION

The invention relates to retail displays of products and methods of displaying products in retail displays.

### BACKGROUND OF THE INVENTION

Often manufacturers and marketers of consumer products wish to appeal to consumers of related goods, products, or services. For example, a marketer of toothpaste may wish to attract consumers of certain mouthwash. Likewise, a marketer of shampoo may wish to attract consumers of a certain kind of conditioner. In general, many products have related benefits but are marketed under different brands, or by different companies, so that consumers cannot make a connection between the different products resulting in a purchasing decision.

In some cases it may be that a company selling one brand of product may wish to cooperate with a different company selling another brand of product by co-marketing their respective products. By doing so, each company hopes to gain consumers that use the other company's products, but not theirs. If the products are for unlike uses each company stands to gain consumers by appealing to consumers of the other company's products. In a similar manner, a manufacturer and marketer of two brands of products may with to co-market the two brands so that consumers purchase both brands.

Co-marketing, or co-merchandising, that is, advertising or displaying products together in a retail environment so as to prompt a purchasing decision of one or both of the products based on the association of the two in the retail environment is known. However, often consumers have no reason to make a purchasing decision based solely on the juxtaposition of two or more products.

Accordingly, it would be desirable to have a method of marketing products in which a consumer was provided a reason to purchase one or both of two co-marketed products or services.

Further, it would be desirable to have a retail display in which two or more branded products were adapted to prompt a purchasing decision of one of the products by a consumer not previously disposed to purchase the product.

Additionally, it would be desirable to have an improved method for prompting purchasing decisions in which a consumer of one brand is encouraged to purchase a different brand.

### BRIEF DESCRIPTION OF THE DRAWINGS

FIG. 1 is a perspective view of one embodiment of the present invention.

FIG. 2 is a detail of first brand identifier and a common mark of the present invention.

FIG. 3 is a detail of a second brand identifier and a common mark of the present invention.

FIG. 4 is a perspective view of another embodiment of the present invention.

### SUMMARY OF THE INVENTION

A retail display for consumer products and method of display is disclosed. A first packaged disposable absorbent product exhibiting on the package a first brand identifier and a second packaged disposable absorbent product exhibiting on the package a second brand identifier different from said first brand identifier are disclosed. The second package is packaged separately from the first package. An additional mark is on each separately-packaged first and second disposable absorbent products, the additional mark being common to both, and the additional mark communicating an attribute common to each of said first and second products. Both the first or second brand identifier and the common mark are observable by a consumer at a retail point of sale.

### DETAILED DESCRIPTION OF THE INVENTION

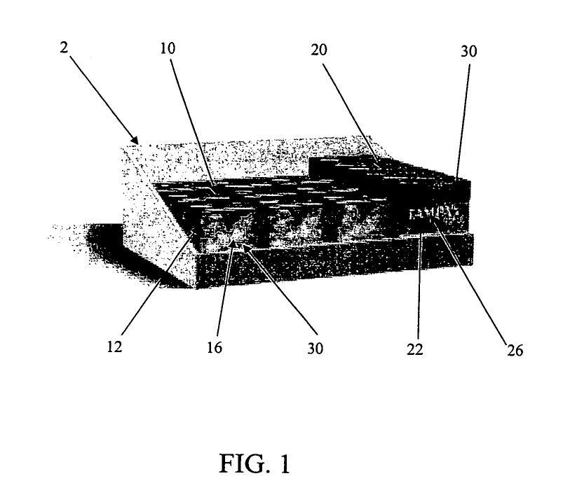

FIG. 1 shows one embodiment of a display of the present invention which is configured according to the method of the present invention. As shown in FIG. 1 a shelf tray 2 can have packaged products placed therein for placement on a shelf of a retail establishment. Often shelf trays are pre-packaged by the manufacturer of a consumer product so that the retail seller simply places the tray as-is onto a shelf in the retail store.

As shown in FIG. 1, a display 2 of the present invention includes a first product 10 and a second product 20, the first and second products being products sold under distinct and different brand identifiers. Brand identifiers can be brand names, trademarked product identifiers, store brands, private label brands, trademarks, trade names, and the like. For example, as shown in FIG. 1, first product 10 can be a sanitary napkin sold under the ALWAYS® brand name and packaged in a first package 12 exhibiting on the package a first brand identifier 16, for example, the ALWAYS® mark. Likewise, a second product 20 can be a tampon sold under the TAMPAX® brand name and packaged in a second package 22 exhibiting on the package a second brand identifier 26, for example, the TAMPAX® mark.

First and second products are separately packaged. By separately packaged is meant that the first and second products are not “bundled” or otherwise joined, attached, wrapped, or provided together for purchase by the consumer. The consumer can remove and/or purchase one or the other of the first or second package from the retail shelf display, without being required to remove or purchase the other package.

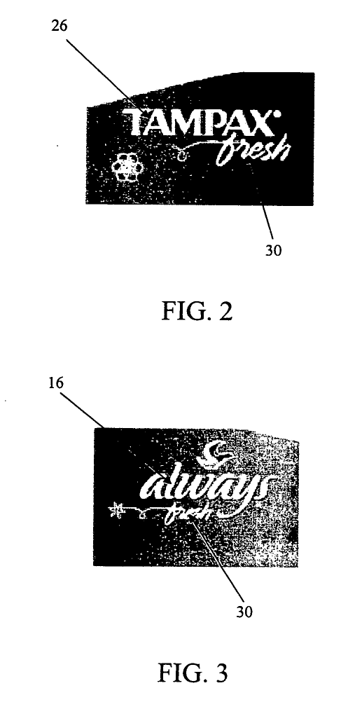

In addition to the brand identifiers exhibited on each of the first and second packages, each package can have an additional mark common to both packages. That is, in addition to the brand identifiers on the separately-packaged first and second packages, each of the first and second packages can have exhibited thereon an additional mark that is common to both. For example, for the embodiment shown in FIG. 1, each brand identifier can have associated with it a common mark 30, such as the subnomen “fresh” as shown in detail in FIGS. 2 and 3. The common mark 30 can be a word, logo, emblem, graphic design, shape, color, or other mark.

By using a common mark, a manufacturer and marketer of a consumer product can communicate to a consumer reasons why the consumer might with to purchase one or the other of the first or second packaged products. For example, for the embodiment shown in FIG. 1, a user of ALWAYS® sanitary napkins that also uses tampons might not use TAMPAX® tampons, and vice-versa. The manufacturer and marketer of one of either the first or second packaged product may with to “link” their product to the other by communicating a common attribute in order to influence a purchasing decision by the consumer. In the embodiment shown, the subnomen “fresh” can be used to communicate a common scent, for example. The subnomen “fresh” may be used to communicate a common absorbent capacity, or a common odor control efficacy, or a common botanical extract, or a common skin health ingredient, or a common cleaning efficacy, for example. The common mark should be visible to the consumer at the point of sale.

By shelving first and second packaged products having different brand identifiers in close proximity on a store shelf, for example, in the same shelf tray or on the same end-of-aisle display, the consumer is able to see the common mark, and thereby be informed of a common attribute. By communicating a common attribute to the consumer, the consumer can make an informed decision to purchase one or the other, and perhaps both, of the first or second packaged product.

While the present invention is particularly useful in the product category of disposable absorbent articles, it can find equal utility in other categories such as oral care products, baby care products, fabric care products, pet care products, health care products, floor care products, car care products, laundry care products, electronic products. Non-limiting examples can include as first and second products, respectively, toothpaste and mouthwash, diapers and wipes, detergent and fabric softener, toilet tissue and facial tissue, snack foods and beverages, shampoo and conditioner, razor blades and shaving cream, dry mops and floor cleaning compositions, printers and ink cartridges, coffee and coffee filters, electronic gear and batteries, dog food and dog treats, and the like. For each of the above, a product from different brand names can be identified and paired together with a common mark for marketing at the point of sale. To take one example, CREST® toothpaste and SCOPE® mouthwash could be separately packaged and shelved, with each package carrying a common mark such as a picture or graphic design of a white tooth, or a word, such as “sparkle,” or any other mark communicating a common attribute such as teeth cleaning or refreshing taste.

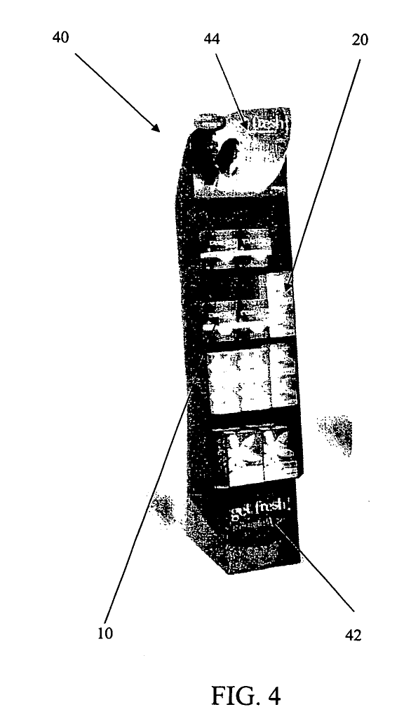

FIG. 4 shows another embodiment of the invention where instead of a shelf tray, first and second products are displayed on a floor stand, which can be an end-of-aisle display. Floor stand 40 can have shelves therein for placing first packaged products 10 and second packaged products 20 thereon. In the example shown in FIG. 4, first packaged products 10 are sanitary napkins and second packaged products 20 are tampons. As shown in FIGS. 2 and 3, the brand identifiers of the first and second products shown in FIG. 4 can have the same common mark, namely the word “fresh.” The common mark can be placed on the floor stand by printing directly on the floor stand as shown at the bottom 42 of floor stand 40 or on an additional member attached to the floor stand as shown in the floor stand common mark member 44 at the top of floor stand 40.

As shown in FIG. 4, in one embodiment of the invention, a portion of the retail shelf display, such as the shelf tray or the floor stand can exhibit the common mark to further communicate a common attribute of the first and second products. As shown, for example, the words “get fresh” can reinforce the common mark “fresh” and communicate the common attribute of the displayed products. Further words and phrases can reinforce the common mark to further communicate the attribute, such as words explaining a fresh scent, or a fresh feeling of dryness, or a fresh sensation of odor control, or the like.

Additionally, promotional items such as coupons, information booklets, in-store displays, shelf talkers, advertising fliers, commercial media spots, can each carry the common mark to reinforce the common attribute between the first and second branded products. For example, the word mark “fresh” can be accompanied by explanations of a particular benefit, such as, scent, odor control, tactile sensation, visual perception, or the like.

What is claimed is:

1. A method of displaying disposable absorbent products to a consumer in a retail environment, the method comprising the steps of:
a. providing a first packaged disposable absorbent product exhibiting on the package a first brand identifier;
b. providing a second packaged disposable absorbent product exhibiting on the package a second brand identifier different from said first brand identifier, said second package being packaged separately from said first package;
c. providing on each separately-packaged disposable absorbent first and second products an additional mark common to both and communicating an attribute common to each of said first and second disposable absorbent products;
d. shelving the first and second disposable absorbent products in a retail display environment such that both the first or second brand identifier and the common mark are observable by a consumer.

2. The method of claim 1, wherein the first and second disposable absorbent products are selected from the group consisting of baby care products, pet care products, health care products, floor care products, car care products, and feminine care products.

3. The method of claim 1, wherein the common attribute is a common scent.

4. The method of claim 1, wherein the common attribute is a feature selected from the group consisting of a common scent, a common tactile impression, a common absorbent capacity, a common odor control efficacy, a common botanical extract, a common cleaning efficacy, and a common skin health ingredient.

5. The method of claim 1, wherein the common marking is selected from the group consisting of a subnomen, a word, a logo, an emblem, a graphic design, a shape, a color, and combinations thereof.

6. The method of claim 1, wherein the retail display environment comprises a shelf tray.

7. The method of claim 1, wherein the retail display environment comprises a floor stand.

8. A retail display for consumer products, said display comprising:
a. a first packaged disposable absorbent product exhibiting on the package a first brand identifier;
b. a second packaged disposable absorbent product exhibiting on the package a second brand identifier different from said first brand identifier, said second package being packaged separately from said first package;
c. an additional mark on each separately-packaged first and second disposable absorbent products and common to both, said additional mark communicating an attribute common to each of said first and second disposable absorbent products; and wherein
d. both the first or second brand identifier and the common mark are observable by a consumer at a retail point of sale.

9. The retail display of claim 8, wherein the first and second disposable absorbent products are disposable absorbent articles.

10. The retail display of claim 8, wherein the first and second disposable absorbent products are selected from the group consisting of baby care products, pet care products, health care products, floor care products, car care products, and feminine hygiene products.

11. The retail display of claim 8, wherein the common attribute is a common scent.

12. The retail display of claim 8, wherein the common attribute is a feature selected from the group consisting of a common scent, a common tactile impression, a common absorbent capacity, a common odor control efficacy, a common botanical extract, a common cleaning efficacy, and a common skin health ingredient.

13. The retail display of claim 8, wherein the common marking is selected from the group consisting of a subnomen, a word, a logo, an emblem, a graphic design, a shape, a color, and combinations thereof.

14. The retail display of claim 8, wherein the retail display environment comprises a shelf tray.

15. The retail display of claim 8, wherein the retail display environment comprises a floor stand.
